(19) United States
(12) Patent Application Publication
(10) Pub. No.: US 2002/0179806 A1
(43) Pub. Date: Dec. 5, 2002

(54) Adjustable force damper for passive vibration control

(76) Inventor: Ting-Chien Teng, Fremont, CA (US)

Correspondence Address: RITTER, LANG & KAPLAN, 12930 SARATOGA AE. SUITE D1, SARATOGA, CA, 95070, US

(21) Appl. No.: 09/871,549

(22) Filed: May 30, 2001

(51) Int. Cl. F16M 13/00

(52) U.S. Cl. 248/618

(57) ABSTRACT

Methods and apparatus for damping out vibrations associated with a structure are disclosed. According to one aspect of the present invention, a structure includes a mass and a vibration damper. The mass has a first surface and a second surface, and is arranged to transfer vibratory energy. The vibration damper includes a force adjuster, as well as a first energy dissipator and a second energy dissipator. The vibration damper is positioned about the mass so that the first energy dissipator is in contact with the first surface and the second energy dissipator is in contact with the second surface. The first energy dissipator and the second energy dissipator absorb the vibratory energy transferred by the mass, while the force adjuster adjusts force on the first energy dissipator and force on the second energy dissipator. In one embodiment, the mass is a beam.

### BACKGROUND OF THE INVENTION

1. Field of Invention

The present invention relates generally to controlling vibrations in mechanical systems. More particularly, the present invention relates to a force damper which dampens vibrations in a mechanical system without adding significant weight to the mechanical system.

2. Description of the Related Art

For precision instruments such as semiconductor wafer positioning stages, factors which affect the performance, e.g., accuracy, of the precisions instruments generally must be dealt with and, most often, eliminated. When the performance of a precision instrument is adversely affected, as for example by vibrations, products formed using the precision instrument may be improperly formed and, hence, function improperly. While most adverse factors are generally accounted for in the design of the precision instruments, some factors may not manifest themselves until after the precision instruments are built.

A stage assembly such as a wafer stage assembly may include a sensor system, for example, which may produce inaccurate readings when portions of the stage assembly are subjected to vibration. FIG. 1 is a diagrammatic representation of a portion of a stage assembly. A stage assembly 102 generally includes a linear-motor magnetic track 106 which is supported by a track mount 110. Track mount 110, in turn, may be supported by base structures 114. In general, base structures 114 may be substantially fixably mounted to a surface, e.g., an inner surface of a vacuum chamber.

A scanning stage, which is arranged to move within magnetic track 106, i.e., is coupled to a linear motor, and may be arranged to scan wafers or reticles, as for example within an electron beam projection system. Specifically, a scanning stage may be sized to accommodate wafers to be etched or reticles used in an etching process. A scanning stage, as represented by stage 118, moves partially within magnet track 106. In order to monitor the position of stage 118, in order to ensure positioning accuracy of stage 118, a sensing system is often implemented. As will be appreciated by those skilled in the art, a sensing system often includes a sensor and an emitter. A sensor and an emitter are included in a position sensor 122, which is mounted on a sensor mount 124. An emitter portion of position sensor 122 may be arranged to beam a signal such as a light beam off of a side surface 126 of stage 118, and a sensor portion of position sensor 122 may be arranged to receive the reflected beam. Using information associated with the reflected beam, position sensor 122 may determine or cause a determination of a current position of stage 118.

When machined and assembled properly, stage assembly 102 should not include vibrations significant enough to greatly affect the operation of position sensor 122. That is, stage assembly 102 is typically designed to minimize vibrations associated with stage assembly 102 during the operation of stage assembly 102. However, manufacturing and assembly inconsistencies, as well as other factors, e.g., external vibrations, may cause at least one of sensor mount 124 and stage 118 to exhibit vibratory motion. When sensor mount 124 is subject to vibration, position sensor 122 may vibrate, and inaccurately send and receive signals. Alternatively, when stage 118 vibrates, the reflection of signals off of surface 126 may be affected, thereby leading position sensor 122 to receive a signal which has not been properly reflected.

FIG. 2 is a diagrammatic representation of a beam, such as sensor mount 124 of FIG. 1, which is subject to vibration. As shown, a sensor mount 224 may vibrate, thereby causing a sensor 222 mounted on sensor mount 224 to vibrate. In other words, sensor mount 224 may be subject to a structural vibration which shakes sensor 222. Although the magnitude of the vibrations may be relatively small, as depicted by sensor mount 224a at an initial time, sensor mount 224b at a time T1, and sensor mount 224c at a time T2, the vibrations may affect the performance of position sensor 222.

Typically, in order to reduce the frequency of vibrations, a mass damper may be added to sensor mount 224. FIG. 3 is a diagrammatic representation of a sensor mount, e.g., sensor mount 224a of FIG. 2, which includes a mass damper. A mass damper is often formed from a mass 304 and a damper 308, or just a mass. Mass 304 and damper 308, which may be a material such as rubber, are often positioned on sensor mount 224a to minimize vibrations. By way of example, mass 304 and damper 308, or just mass 304 in some cases, may be positioned over a nodal point associated with sensor mount 224a to effectively damp out vibrations by changing the frequency of the vibrations.

Although the use of a mass damper is often effective in correcting for vibration effects on structures such as sensor mounts, i.e., by changing the frequency of vibration, the use of a mass damper may be impractical in some situations. For instance, some structures may be too small to allow for a substantive mass to be positioned on the structure, e.g., sensor mount 124 of FIG. 1 may not be large enough to accommodate both position sensor 122 and a mass damper. In addition, for a moving beam such as a stage, e.g., stage 118 of FIG. 1, adding mass causes additional force to be required to move the beam. Requiring additional force to move the beam may require an associated linear motor to generate more power, and may lead to additional issues with regards to controlling the movement of the beam.

Therefore, what are needed are a method and an apparatus for correcting for vibrations effects on structures that does not require the addition of a relatively substantial mass to the structure. That is, what is desired is a damping system which is suitable for effectively damping out vibrations on structures without the use of a significantly sized mass.

### SUMMARY OF THE INVENTION

The present invention relates to at least partially damping out vibrations in a structure. According to one aspect of the present invention, a structure includes a mass and a vibration damper. The mass has a first surface and a second surface, and is arranged to transfer vibratory energy. The vibration damper includes a force adjuster, as well as a first energy dissipator and a second energy dissipator. The vibration damper is positioned about the mass so that the first energy dissipator is in contact with the first surface and the second energy dissipator is in contact with the second surface. The first energy dissipator and the second energy dissipator absorb the vibratory energy transferred by the mass, while the force adjuster adjusts force on the first energy dissipator and force on the second energy dissipator. In one embodiment, the mass is a beam. In another embodiment, the mass is a core of a motor.

The use of a force damper enables vibrations in a structure such as a beam to be at least partially suppressed without effectively adding a substantial amount of mass to the structure. As the force damper provides forces on opposite sides of the structure, any mass associated with the force damper effectively balances out. Hence, when the structure is a moving beam, the axis through which the beam is driven is essentially not altered by the addition of any mass associated with the force damper. As a result, issues associated with adding additional mass to a moving beam may be avoided.

According to another aspect of the present invention, a structure includes a mass that has a first surface and a second surface, and is capable of transferring vibratory energy which may cause the mass to vibrate. The structure also includes a force damper. The force damper includes a first absorber and a second absorber, and is positioned about the mass such that the first absorber is in contact with the first surface of the mass when the force damper applies a first force to the first surface of the mass and the second absorber is in contact with the second surface of the mass when the force damper applies a second force to the second surface of the mass. The first absorber and the second absorber absorb the vibratory energy transferred by the mass when the force damper applies the first force and the second force.

In one embodiment, the first force is applied to the first surface of the mass through the first absorber, and the second force is applied to the second surface of the mass through the second absorber. In such an embodiment, an adjuster may be adjusted to vary at least one of the first force and the second force, and an amount of the vibratory energy absorbed by the first absorber and the second absorber is varied when at least one of the first force and the second force are varied.

According to still another aspect of the present invention, a stage assembly that is suitable for use in wafer processing includes a base, a stage, a mount, a sensor, and a force damper. The mount is coupled to the base, and has a first surface and a second surface. The sensor is coupled to the mount, and measures a position of the scanning stage. The force damper includes a first absorber and a second absorber. The position of the force damper about the mount is such that the first absorber is in contact with the first surface of the mount when the force damper applies a first force to the first surface of the mount and the second absorber is in contact with the second surface of the mount when the force damper applies a second force to the second surface of the mount. The first absorber and the second absorber absorb vibratory energy transferred by the mount when the force damper applies the first force and the second force, which substantially opposes the first force. In one embodiment, the stage assembly is a part of an exposure apparatus.

According to yet another aspect of the present invention, a method for suppressing vibrations in a structure that has a mass which has a first surface, and a second surface involves providing a first absorber on the first surface and providing a second absorber on the second surface. A first force which has a first magnitude is applied to the first absorber by a device. The first absorber absorbs a first amount of vibratory energy associated with the mass. A second force is applied to the second absorber, which absorbs a second amount of vibratory energy, by the device. The second force has a second magnitude that is approximately equal to the first magnitude. In one embodiment, the first force and the second force are applied in substantially opposing directions along an axis of the device.

In accordance with still another aspect of the present invention, a method for positioning an object includes moving the object along a predetermined direction, and measuring the position of the object using a sensor that is coupled to a sensor mount. A first force of a first magnitude is applied to the first surface of the sensor mount, and a second force of a second magnitude, which is substantially equal to the first magnitude, is applied to the second surface of the sensor mount. In one embodiment, the method for positioning an object is included in a method for operating an exposure apparatus.

These and other advantages of the present invention will become apparent upon reading the following detailed descriptions and studying the various figures of the drawings.

### BRIEF DESCRIPTION OF THE DRAWINGS

The invention may best be understood by reference to the following description taken in conjunction with the accompanying drawings in which:

FIG. 1 is a diagrammatic representation of a portion of a wafer stage assembly.

FIG. 2 is a diagrammatic representation of a vibrating sensor mount and sensor.

FIG. 3 is a diagrammatic representation of a sensor mount, i.e., sensor mount 224a of FIG. 2, with an added mass damper.

FIG. 4A is a force diagram of a sensor mount with added force dampers in accordance with an embodiment of the present invention.

FIG. 4B is a diagrammatic representation of a sensor mount, a sensor, and a force damper in accordance with an embodiment of the present invention.

FIG. 5A is a force diagram of a sensor mount with added force dampers in accordance with another embodiment of the present invention.

FIG. 5B is a diagrammatic representation of a sensor mount, a sensor, and a force damper in accordance with another embodiment of the present invention.

FIG. 6A is a diagrammatic perspective representation of a high-precision positioning instrument with a coarse stage and a fine stage controlled with EI-core actuators.

FIG. 6B is a diagrammatic representation of two complementary EI-core actuators attached to a fine stage.

FIG. 6C is a diagrammatic representation an EI-core motor with a force damper in accordance with an embodiment of the present invention.

FIG. 7 is a diagrammatic representation of a photolithography apparatus which includes a force damper in accordance with an embodiment of the present invention.

FIG. 8 is a process flow diagram which illustrates the steps associated with fabricating a semiconductor device in accordance with an embodiment of the present invention.

FIG. 9 is a process flow diagram which illustrates the steps associated with processing a wafer, i.e., step 1304 of FIG. 9a, in accordance with an embodiment of the present invention.

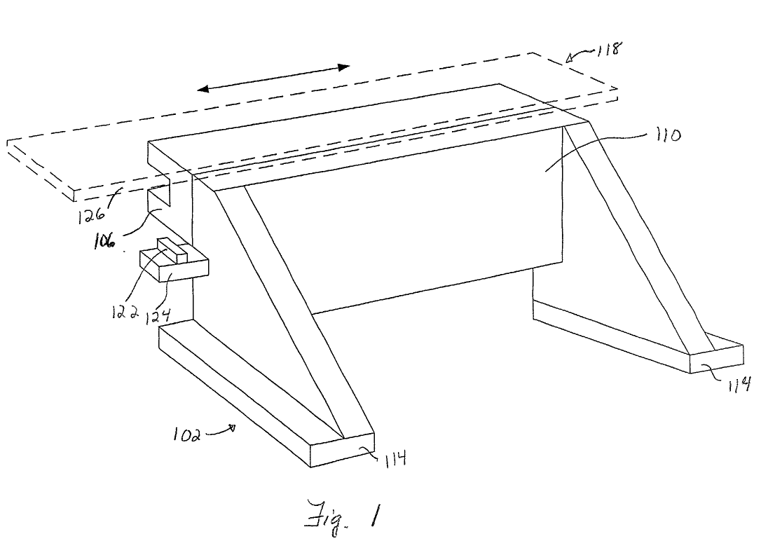

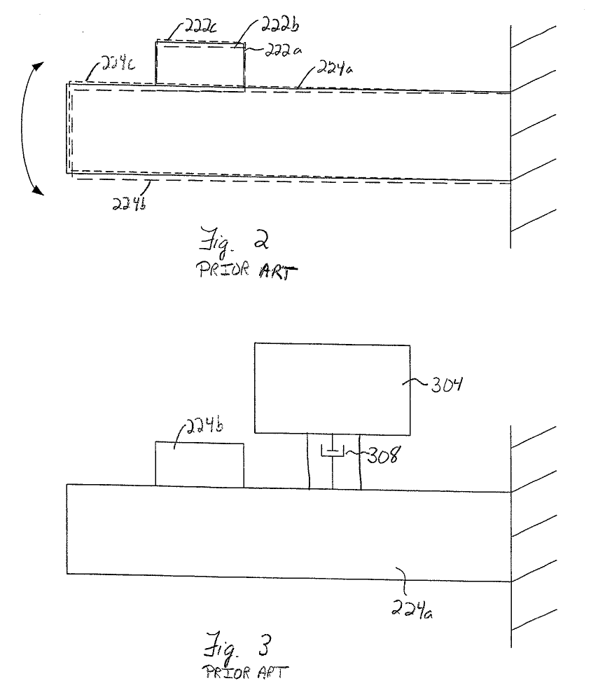

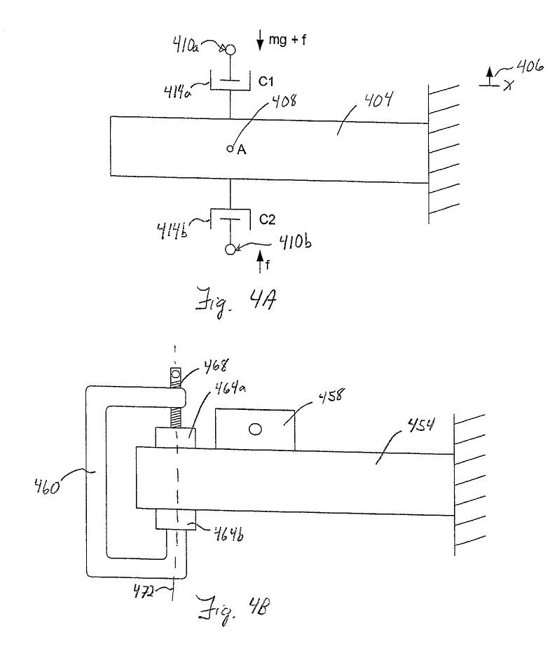

### DETAILED DESCRIPTION OF THE EMBODIMENTS

When vibrational modes are discovered to exist in structures, it is often desirable to dampen the vibrational modes. For example, for precision machinery such as a stage apparatus which is used in semiconductor wafer processing, vibrations may cause positioning errors with respect to the wafers. Vibrations may also cause sensors associated with the stage apparatus to function inaccurately. While adding mass dampers may be effective in reducing vibrations, mass dampers generally do not dissipate vibrational energy, and space constraints within a stage apparatus may render the use of mass dampers as unfeasible. Further, adding mass dampers to moving parts, e.g., a scanning stage, often causes issues which may include increasing the power required to move the parts.

By adding a force damper to a structure, vibrational energy may be passively absorbed or dissipated substantially without requiring the addition of a substantial mass. The mass of the force damper may be minimized while still enabling vibrations to be attenuated, generally without greatly affecting the force created by the force damper. In other words, the mass of a force damper has been observed to be substantially independent of the magnitude of the force provided by the force damper.

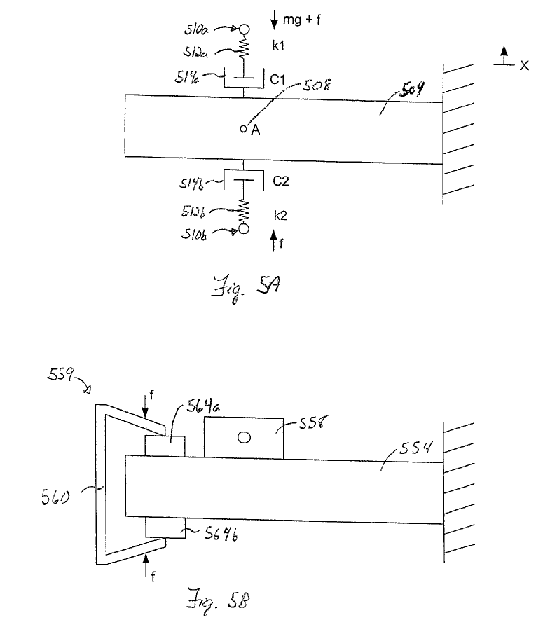

FIG. 4A is a diagrammatic representation of a sensor mount, e.g., a cantilever beam, which is under the influence of a theoretical force damper in accordance with an embodiment of the present invention. A beam 404 has a point A 408, which may be a center of mass of beam 404. In one embodiment, point A 408 may be an effective center of mass of beam 404 which also accounts for the weight of a sensor (not shown) that is mounted on beam 404. Point A 408 may be a center node associated with modes of vibration. It should be appreciated that while vibrational energy associated with beam 404 may generally cause vibrations in substantially any plane, the vibrations most often occur in an x-direction as indicated by direction 406.

A force damper 410, which includes a damper 414a which has a damping coefficient C1 and a damper 414b which has a damping coefficient C2, has a mass m. In general, the damping coefficients of dampers 414 differ, i.e., damping coefficient C1 is not equal to damping coefficient C2. Force damper 410 applies a force f in a negative x-direction, and a force f in a positive x-direction through point A 408. As shown, section 410a applies a force f in a negative x-direction, while section 410b applies a force f in a positive x-direction. Although the forces applied by force damper 410 on dampers 414 may have different magnitudes such that the magnitude of the force on damper 414a is not the same as the magnitude of the force on damper 414b, the forces applied by force damper 410 onto dampers 414 typically have approximately the same magnitude.

Balancing forces along an x-direction about point A 408 yields a relationship that shows that the force on point A 408 is dependent upon the mass m of force damper 410, e.g., a mass multiplied by gravity term, and the damping coefficients of dampers 414, e.g., a term which reflects the difference between C1 and C2 multiplied by a velocity in the x-direction. It should be understood that while point A 408 has been described as being a center of mass of beam 404, point A 408 may generally be any point through which forces are applied by force damper 410.

As previously stated, the force f applied by force damper 410 is not significantly affected by the mass m of force damper 410. Accordingly, mass m of force damper 410 may be substantially minimized without greatly affecting force f. By minimizing mass m, it may not be necessary to increase power requirements associated with moving beam 404 to preserve approximately the same bandwidth associated with moving beam 404 when mass m is not present, for an embodiment in which beam 404 is to be moved. Hence, under the assumption that the mass multiplied by gravity term is insignificant when compared with the difference between C1 and C2 multiplied by a velocity term, then the force on point A 408 may be considered as being proportional to the difference between C1 and C2 multiplied by a velocity term.

Since the force on point A 408 is effectively proportional to the difference between C1 and C2, by varying C1 and C2, the force on point A 408 may be varied. As a result, the amount of damping provided to dampen out vibrations in beam 404, or the amount of vibrational energy which may be absorbed, may be varied by varying C1 and C2.

In one embodiment, an ideal force damper, i.e., a force damper 410 with minimum mass, may be physically approximated by a clamp such as a C-clamp. With reference to FIG. 4B, a sensor mount which supports a sensor and is under the affect of a force damper will be described in accordance with an embodiment of the present invention. A sensor mount 454, which may be a beam structure, supports a sensor 458, and may be subjected to vibrational energy. A clamp 406 is positioned about beam 454 such that clamp 406 holds absorbers 464 in contact with sensor mount 454. When force is applied to absorbers 464 through clamp 406, sensor mount 454 effectively transfers vibrational energy to absorbers 464 which absorb, or dissipate, the energy.

Absorbers 464, which may be rubber pads in one embodiment, have associated damping coefficients which generally be altered by varying the force applied to absorbers 464 by clamp 406. As shown, clamp 406 generally has an axis 472 along which force is applied. Positioning absorbers 464 about axis 472 such that force is applied by clamp 406 through absorbers 464 allows the damping coefficients of absorbers 464 to essentially be altered. Typically, increasing the amount that absorbers 464 are compressed increases the damping coefficients of absorbers 464. Hence, the amount of vibrational energy which may be absorbed and dissipated by absorbers 464 may be increased as the amount of compression associated with absorbers 464 increases.

To vary the force on absorbers 464 and, as a result, to vary the amount by which vibrations in sensor mount 454 may be dampened, a set screw 468 of clamp 460 may be adjusted. That is, tightening setscrew 468 generally increases the amount of vibrational energy that is absorbed by absorbers 464, while loosening setscrew 468 generally reduces the amount of vibrational energy that is absorbed by absorbers 464. It should be appreciated that set screw 468 is generally a mechanism used to adjust a compressive force produced by clamp 460, i.e., set screw 468 may be generally considered to be a mechanism used to vary the magnitude of an applied clamp force.

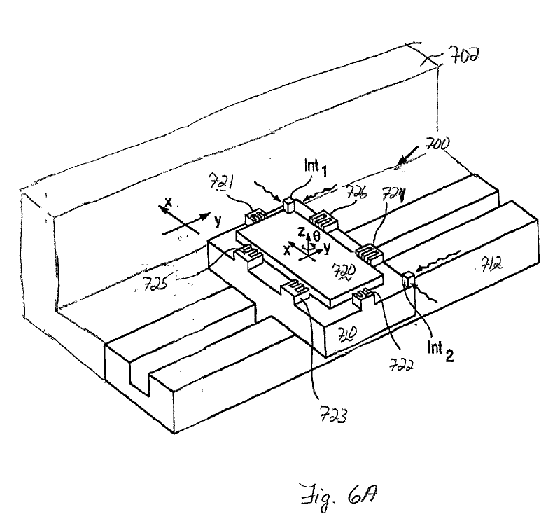

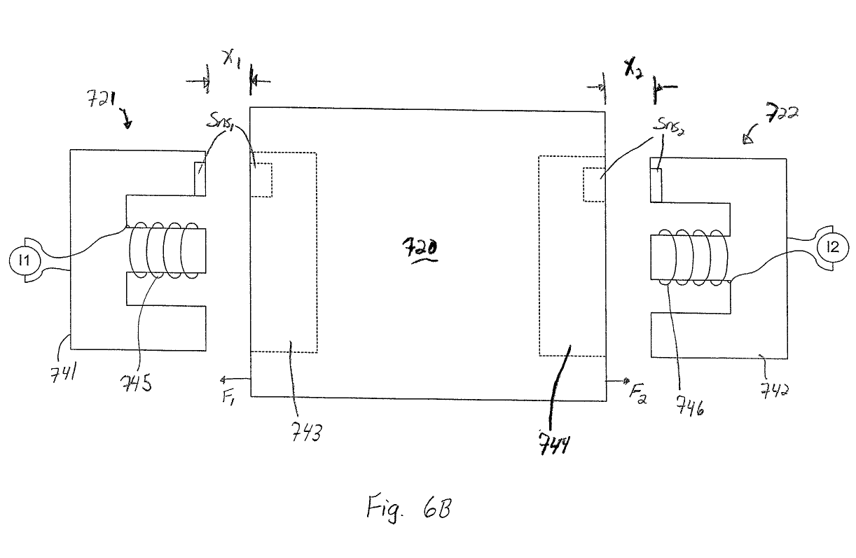

While a force damper that may be approximated as including a damper is suitable for use in dampening out vibrations, other configurations of force dampers may also be effective in damping out vibrations. For example, a force damper which may be approximated as including a damper and a spring may be used. That is, a force damper may have spring-like characteristics. FIG. 5A is a diagrammatic representation of a sensor mount or, more generally, a beam structure, which is under the influence of a theoretical force damper that includes spring-like characteristics in accordance with an embodiment of the present invention. A beam 504 has a point A 508, which may be a center of mass A 508 of beam 504.

A force damper 510 is positioned about beam 504 to coincide with point A 508. That is, force damper 510 is arranged to effectively apply forces f through point A 508, irregardless of whether point A 508 coincides with the center of mass of beam 504. Force damper 510 has an associated mass m, and includes a damper 514a which has a damping coefficient C1, as well as a damper 514b which has a damping coefficient C2. A spring 512a to which a force f is applied is coupled to damper 514a, while a spring 512b, also through which a force f is applied, is coupled to damper 514b. In general, the damping coefficients of dampers 514 differ, i.e., damping coefficient C1 is not equal to damping coefficient C2. Spring constants k1 and k2, which are associated with spring 512a and spring 512b, respectively, also differ.

Summing forces along an x-direction about point A 508 yields a relationship that shows that the overall force on point A 508 is dependent upon the mass m of force damper 510, the damping coefficients of dampers 514, and the spring constants of springs 512. Further, the damping coefficients of dampers 514 is dependent upon both the magnitude of applied force f, as well as the effective spring constants of springs 512. In other words, damping coefficient C1 is a function of spring constant k1 and force f, while damping coefficient C2 is a function of spring constant k2 and force f.

By minimizing mass m of force damper 510, force f may be maintained without raising issues relating to power requirements for moving beam 504. In addition, in some cases, minimizing mass m may also reduce the physical size of force damper 510. As a result, the amount of space occupied by force damper may be substantially minimized without greatly affecting force f. When mass m is minimized, then the sum of forces at point A 508 in an x-direction is dependent substantially only on the difference between damping coefficients C1 and C2, which may be partially dependent upon spring constants k1 and k2, respectively. Therefore, by varying C1 and C2, or by varying C1, C2, k1, and k2, the force on point A 508 may be varied. As previously mentioned, varying the force on point A 508 essentially varies the amount of damping provided to dampen out vibrations in beam 504, or the amount of vibrational energy which may be absorbed.

A spring which is suitable for use as a part of a force damper may be a spring which has the propensity to be in a “clamped” or compressed position unless a force is used to “open” or stretch the spring. Such a spring will be described with reference to FIG. 5B. FIG. 5B is a diagrammatic representation of a sensor mount which is configured as a beam, a sensor, and a force damper with spring-like characteristics in accordance with an embodiment of the present invention. A beam 554 has a sensor 558 mounted thereon, and may be subject to vibrations. In an effort to dissipate the vibrational energy in beam 554, a force damper 559 which includes a spring 560 and absorbers 564 is positioned about beam 554. Spring 560, which is effectively configured as a clamped spring, clamps down on absorbers 564 to apply a force f on each of absorbers 564a and 564b. The strength of force f, which may be considered to be a spring clamping force, may be altered by varying the size of spring 560, as well as the material from which spring 560 is formed.

Spring 560 may be formed from substantially any suitable material which enables spring 560 to be repeatedly compressed and uncompressed without failing, e.g., without greatly fatiguing. Spring 560 may be a constant force spring which applies substantially the same force f irregardless of how clamped, or compressed, spring 560 is. In one embodiment, spring 560 may be formed from a thin metal or a plastic material which is capable of sustaining a clamping force.

Absorbers 564, which may be rubber pads, absorb vibrational energy that is transferred from beam 554. The amount of energy absorbed by absorbers 564 is dependent upon the amount of force that is effectively exerted by absorbers 564 on surfaces of beam 554. As shown, absorbers 564 are positioned such that absorber 564 is in contact with a top surface of beam 554, while absorber 564b is in contact with a bottom surface of beam 554. In other words, absorbers 564 are positioned on opposite or opposing surfaces of beam 554.

As discussed above, the strength of force f exerted by spring 560 on absorbers 564 affects the force exerted by absorbers 564 on beam 554. The dimensions, e.g., thicknesses, of absorbers 564 as well as the material properties of absorbers 564, e.g., sponginess or density, may also affect the force exerted on beam 554. Therefore, to vary the amount of force that is exerted on beam 554, any combination of the strength of force f, the dimensions of absorbers 564, and the material properties of absorbers 564 may be varied.

In general, the amount of force which is needed to absorb vibrational energy is dependent upon the magnitude of the vibrations which may be created by the vibrational energy. As such, the dimensions and characteristics of a force damper such as force damper 559 of FIG. 5B may be widely varied. For example, for a sensor mount which is subjected to vibrational modes of a relatively small amplitude, a force damper used to damp out the vibrational modes may be configured to dampen out only small amplitude vibrational modes. Alternatively, for a sensor mount which has relatively large amplitude vibrations, a force damper which is suitable for dampening out only relatively small vibrations may not be suitable.

While the use of a force damper is effective for dampening out vibrations in beam-like structures, force dampers may be used to damp out vibrations in a variety of other structures. For example, some motors may flex or vibrate after they are assembled. When a motor flexes, the performance of the motor may be compromised, particularly if the motor is used in a precision application. A motor such as an EI-core motor may be subject to some vibrations. In one embodiment, an EI-core motor which is used as a part of a high-precision positioning instrument may be subject to vibrations.

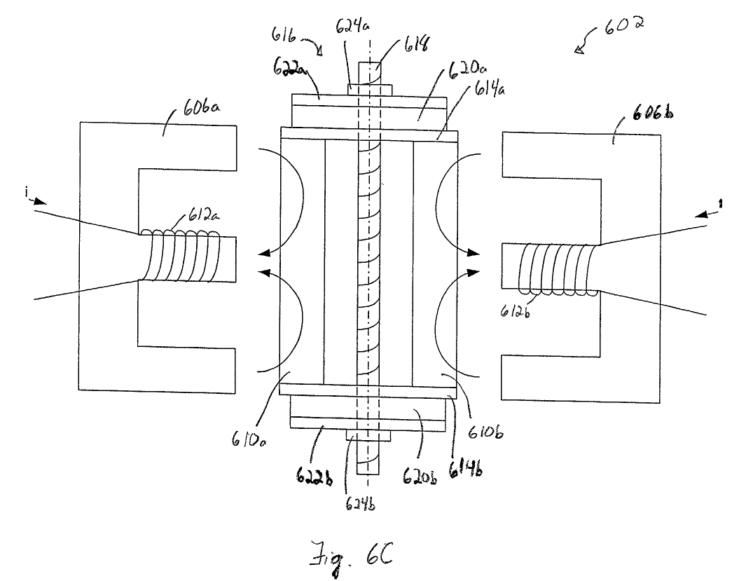

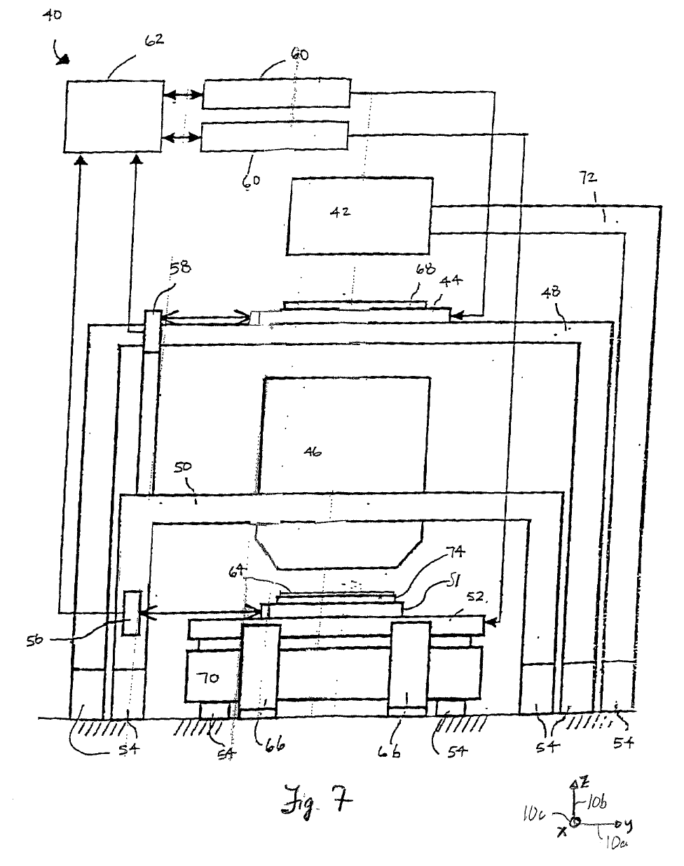

With reference to FIG. 6A, a high-precision positioning instrument which includes EI-core actuators that may be subject to vibrations will be described. A positioning instrument 700, which may be supported by a conventional anti-vibration structure or base 702, includes a coarse stage 710 and a fine stage 720. Coarse stage 710 is driven in a y-direction by a linear servo motor 712 and ball screws, or other appropriate actuators, and is supported vertically by anti-friction bearings, such as air bearings or roller bearings, as is well known in the art. Coarse stage 710 may also be driven in a similar manner in an x-direction.

Fine stage 720 is supported on coarse stage 710 by anti-friction bearings such as air bearings or roller bearings. Fine stage 720 carries an object (not shown) to be positioned in substantially any suitable manner. A semiconductor wafer, for example, may be mounted on fine stage 720 for exposure in a photolithographic system, or any other suitable high-precision positioning system.

Magnetic actuators in the form of six EI-core actuators 721-726, are used to control the position of fine stage 720 relative to coarse stage 710. As shown, EI-core actuators 721-726 are positioned in complementary pairs around fine stage 720 such that fine stage 720 may move with three degrees of freedom in the x, y, and θ_{z} coordinate directions. With additional EI-core actuators (not shown) positioned above and below fine stage 720, however, fine stage 720 may move with up to six degrees of freedom relative to coarse stage 710, which would generally obviate the need for an anti-friction bearing between fine stage 720 and coarse stage 710.

A position sensor Int₁ is located on fine stage 720. Position sensor Int₁ is, for example, an interferometer that senses the actual position of fine stage 720 relative to a stationary object (not shown) such as a projection lens. In this case, the interferometer may include an interferometer block (not shown) supported on base 702 and a mirror (Int₁) mounted on fine stage 720. The interferometer block generally includes an emitter portion and a sensor portion. The emitter portion may be arranged to beam a light beam off the mirror (Int₁), and the sensor portion may be arranged to receive the reflected beam from the mirror Int₁). Using information associated with the reflected beam, the interferometer may determine or cause a determination of a current position of fine stage 720.

It should be understood that position sensor Int₁ may be substantially any other appropriate type of sensor such as a linear encoder. Position sensor Int₁ senses the location of a corner of fine stage 720 in the x-direction and the y-direction. In one embodiment, additional positional sensor may be used to more accurately determine the location of fine stage 720, including the position of fine stage 720 in the z-direction. A second position sensor Int₂ is shown on coarse stage 710. Like position sensor Int₁, position sensor Int₂ is an interferometer or other appropriate measuring device which measures the actual position of coarse stage 710 relative to a stationary object.

FIG. 6B is a diagrammatic representation of a top view of complementary EI-core actuators 721 and 722, and fine stage 720 of FIG. 6A. It should be appreciated that EI-core actuators 723-726 are similar to EI-core actuators 721 and 722. EI-core actuator 721 has a magnetic core component 741, which is shaped like a capital “E,” and a bar core component 743 which is shaped like a letter “I.” EI-core actuator 722, likewise, has a magnetic core component 742 and a bar core component 744. Fine stage 720 may be attached to bar core components 743, 744. Bar core components 743, 744 may be integral parts of fine stage 720. Gap distances x₁ and x₂ are distances between magnetic core components 741, 742 and their respective bar core components 743, 744, which are attached to fine stage 720. In one embodiment, gap distances x₁ and x₂ range between approximately zero and approximately 400 micrometers.

Additionally, EI-core actuators 721, 722 have associated respective gap distance sensors Sns₁ and Sns₂. Gap distance sensors Sns₁ and Sns₂ sense the gap distances x₁ and x₂ between magnetic core components 741 and 742, and respective bar core components 743 and 744. Gap distance sensors Sns₁ and Sns₂ are, for example, capacitor sensors or substantially any other sensor that may accurately measure relatively small distances.

Magnetic core components 741 and 742 have wires 745 and 746, respectively, wound around the center prong of the “E” shape, as shown. Wires 745 and 746 are connected to respective current sources 11 and 12. Magnetic core components 741, 742 or respective EI-core actuators 721, 722 thereby act as electromagnets. Thus, the current that passes through wires 745 and 746 generates a magnetic force in respective magnetic core components 741, 742, as will be understood by those skilled in the art.

The forces on fine stage 720 may generally be expressed as follows:

F₁=k(I₁/x₁)²

F₂=k(I₂/x₂)²

ΔF=F₁−F₂

ΔF=ma

where F₁ and F₂ are the respective forces toward respective magnetic core components 741, 742, as shown in FIG. 6B, k is a constant, I₁ is the D.C. current through windings 745, I₂ is the D.C. current through windings 746, and x₁ and x₂ are gap distances as discussed above. ΔF is the total force on fine stage 720, and m is the mass of fine stage 720 including the mass of bar core components 743, 744.

When an EI-core motor suffers from vibrations, a force damper may be applied to the motor to dissipate the vibrations. If vibrations are not dampened, then a position sensor, e.g., position sensor Int₁ or gap distance sensor Sns1 and Sns2 of FIGS. 6A and 6B, may inaccurately determine the overall position of coarse stage 710. In one embodiment, dampening the vibrations associated with an EI-core motor may include applying an adjustable force damper to the EI-core motor. FIG. 6C is a diagrammatic representation an EI-core motor with a force damper in accordance with an embodiment of the present invention. An EI-core motor 602, which is similar to EI-core actuators described above with respect to FIGS. 6A and 6B, includes magnets 606 and 610. As shown, each of magnets 606 is configured in an “E” shape, and each of magnets 610 is configured in an “I” shape. Flux is generated within motor 602 when current flows through coils 612.

An I-core mount 616, which includes “I” magnets 610 as well as a screw 618, plates 614, and bolts 624 which are arranged to pair or to bind “I” magnets 610 together, often flexes. I-core mount 616 effectively forms an actuator while “E” magnets 606 form an E-core transformer. To attenuate the flexing of I-core mount 616, absorbers 620 may be mounted against plates 614. Absorbers 620, which may be rubber pads in one embodiment, absorb energy which causes flexing in I-core mount 616.

In general, absorbers 620 are held against plates 614, e.g., metal plates, by washers 622. Washers 622, in turn, may be secured against absorbers 620 by bolts 624. By tightening bolts 624, the force of washers 622 against absorbers 620 may be varied, thereby varying the amount of energy which absorbers 620 may absorb and dissipate from I-core mount 616.

Absorbers 620 generally have damping characteristics which may be varied in a variety of different ways. By varying the damping characteristics, the amount of flexing which may be attenuated within EI-core motor 602 may be varied. As stated above, changing the force exerted on absorbers 620 through washers 622 or bolts 624 varies the amount of energy absorbed by absorbers 620 by changing the force exerted by absorbers 620 on plates 614. Other ways in which the forces exerted by absorbers 620 may be varied include, but are not limited to, changing the material properties of absorbers 620, changing the dimensions of absorbers 620, and changing the dimensions of bolts 618 and washers 622.

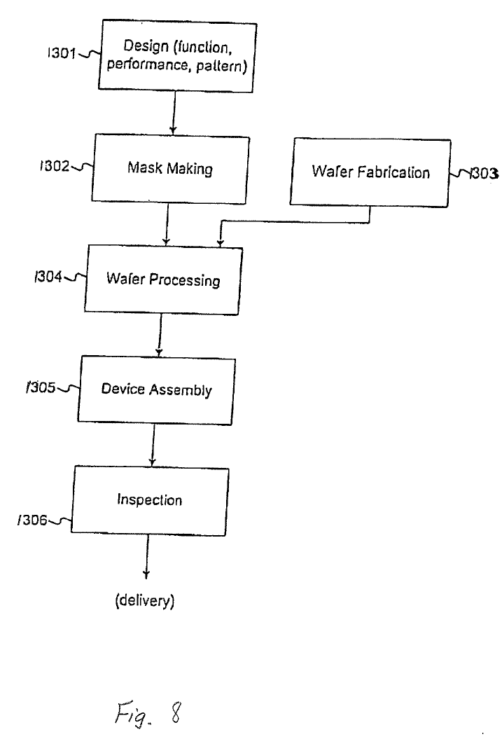

A stage device or apparatus which includes an adjustable force damper, may be a part of an overall photolithography apparatus. Specifically, an adjustable force damper may be used to dampen vibrations in either a wafer stage assembly or a reticle stage assembly in an exposure apparatus which is suitable for use in a photolithography system. With reference to FIG. 7, a photolithography apparatus which includes stage devices with force dampers will be described in accordance with an embodiment of the present invention. A photolithography apparatus (exposure apparatus) 40 includes a wafer positioning stage 52 that may be driven by a planar motor (not shown), as well as a wafer table 51 that is magnetically coupled to wafer positioning stage 52 by utilizing an EI-core actuator. It should be appreciated that, in one embodiment, wafer positioning stage 52 may include a force damper such as an absorber which operates to reduce vibrations associated with an EI-core actuator associated with wafer positioning stage 52. That is, wafer positioning stage 52 may be similar to positioning instrument 700 of FIG. 6A, and may include an EI-core motor such as motor 602 of FIG. 6C which has vibrations that are dampened using absorbers 620.

The planar motor which drives wafer positioning stage 52 generally uses an electromagnetic force generated by magnets and corresponding armature coils arranged in two dimensions. A wafer 64 is held in place on a wafer holder 74 which is coupled to wafer table 51. Wafer positioning stage 52 is arranged to move in multiple degrees of freedom, e.g., between three to six degrees of freedom, under the control of a control unit 60 and a system controller 62. The movement of wafer positioning stage 52 allows wafer 64 to be positioned at a desired position and orientation relative to a projection optical system 46.

Wafer table 51 may be levitated in a z-direction 10b by any number of voice coil motors (not shown), e.g., three voice coil motors. In the described embodiment, at least three magnetic bearings (not shown)couple and move wafer table 51 along a y-axis 10a. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties.

An illumination system 42 is supported by a frame 72. Frame 72 is supported to the ground via isolators 54. Illumination system 42 includes an illumination source, and is arranged to project a radiant energy, e.g., light, through a mask pattern on a reticle 68 that is supported by and scanned using a reticle stage which includes a coarse stage and a fine stage. The radiant energy is focused through projection optical system 46, which is supported on a projection optics frame 50 and may be released to the ground through isolators 54. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optical system 46, and detects the position of reticle stage 44 which supports a reticle 68. In one embodiment, vibrations of reticle stage 44 may be dampened using any of the force dampers described above. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head. Further, the an adjustable force damper may also be applied to a proximity photolithography system that exposes a mask pattern by closely locating a mask and a substrate without the use of a lens assembly. Additionally, an adjustable force damper may be used in other devices including, but not limited to, other semiconductor processing equipment, machine tools, metal cutting machines, and inspection machines.

The illumination source of illumination system 42 may be g-line (436 nanometers (nm)), i-line (365 nm), a KrF excimer laser (248 nm), a ArF excimer laser (193 nm), and an F₂-type laser (157 nm). Alternatively, illumination system 42 may also use charged particle beams such as x-ray and electron beams. For instance, in the case where an electron beam is used, thermionic emission type lanthanum hexaboride (LaB₆) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser is used, glass materials such as quartz and fluorite that transmit far ultraviolet rays is preferably used. When either an F₂-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

Further, in photolithography systems, when linear motors (see U.S. Pat. Nos. 5,623,853 or 5,528,118, which are each incorporated herein by reference in their entireties) are used in a wafer stage or a reticle stage, the linear motors may be either an air levitation type that employs air bearings or a magnetic levitation type that uses Lorentz forces or reactance forces. Additionally, the stage may also move along a guide, or may be a guideless type stage which uses no guide.

Alternatively, a wafer stage or a reticle stage may be driven by a planar motor which drives a stage through the use of electromagnetic forces generated by a magnet unit that has magnets arranged in two dimensions and an armature coil unit that has coil in facing positions in two dimensions. With this type of drive system, one of the magnet unit or the armature coil unit is connected to the stage, while the other is mounted on the moving plane side of the stage.

Movement of the stages as described above generates reaction forces which may affect performance of an overall photolithography system. Reaction forces generated by the wafer (substrate) stage motion may be mechanically released to the floor or ground by use of a frame member as described above, as well as in U.S. Pat. No. 5,528,118 and published Japanese Patent Application Disclosure No. 8-166475. Additionally, reaction forces generated by the reticle (mask) stage motion may be mechanically released to the floor (ground) by use of a frame member as described in U.S. Pat. No. 5,874,820 and published Japanese Patent Application Disclosure No. 8-330224, which are each incorporated herein by reference in their entireties.

As described above, a photolithography system according to the above-described embodiments may be built by assembling various subsystems in such a manner that prescribed mechanical accuracy, electrical accuracy, and optical accuracy are maintained. In order to maintain the various accuracies, prior to and following assembly, substantially every optical system may be adjusted to achieve its optical accuracy. Similarly, substantially every mechanical system and substantially every electrical system may be adjusted to achieve their respective desired mechanical and electrical accuracies. The process of assembling each subsystem into a photolithography system includes, but is not limited to, developing mechanical interfaces, electrical circuit wiring connections, and air pressure plumbing connections between each subsystem. There is also a process where each subsystem is assembled prior to assembling a photolithography system from the various subsystems. Once a photolithography system is assembled using the various subsystems, an overall adjustment is generally performed to ensure that substantially every desired accuracy is maintained within the overall photolithography system. Additionally, it may be desirable to manufacture an exposure system in a clean room where the temperature and humidity are controlled.

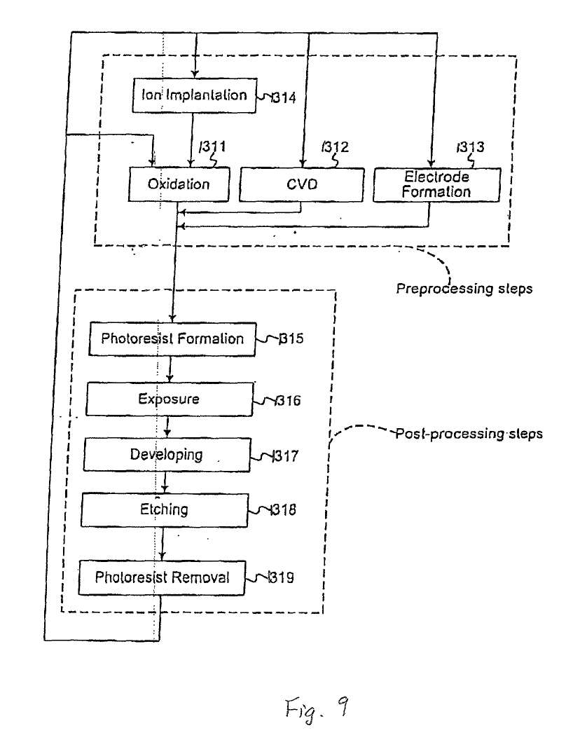

Further, semiconductor devices may be fabricated using systems described above, as will be discussed with reference to FIG. 8. The process begins at step 1301 in which the function and performance characteristics of a semiconductor device are designed or otherwise determined. Next, in step 1302, a reticle (mask) in which has a pattern is designed based upon the design of the semiconductor device. It should be appreciated that in a parallel step 1303, a wafer is made from a silicon material. The mask pattern designed in step 1302 is exposed onto the wafer fabricated in step 1303 in step 1304 by a photolithography system that includes a coarse reticle scanning stage and a fine reticle scanning stage that accelerates with the coarse reticle scanning stage as described above. One process of exposing a mask pattern onto a wafer will be described below with respect to FIG. 9. In step 1305, the semiconductor device is assembled. The assembly of the semiconductor device generally includes, but is not limited to, wafer dicing processes, bonding processes, and packaging processes. Finally, the completed device is inspected in step 1306.

FIG. 9 is a process flow diagram which illustrates the steps associated with wafer processing in the case of fabricating semiconductor devices in accordance with an embodiment of the present invention. In step 1311, the surface of a wafer is oxidized. Then, in step 1312 which is a chemical vapor deposition (CVD) step, an insulation film may be formed on the wafer surface. Once the insulation film is formed, in step 313, electrodes are formed on the wafer by vapor deposition. Then, ions may be implanted in the wafer using substantially any suitable method in step 1314. As will be appreciated by those skilled in the art, steps 1311-1314 are generally considered to be preprocessing steps for wafers during wafer processing. Further, it should be understood that selections made in each step, e.g., the concentration of various chemicals to use in forming an insulation film in step 1312, may be made based upon processing requirements.

At each stage of wafer processing, when preprocessing steps have been completed, post-processing steps may be implemented. During post-processing, initially, in step 1315, photoresist is applied to a wafer. Then, in step 1316, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations.

After the circuit pattern on a reticle is transferred to a wafer, the exposed wafer is developed in step 1317. Once the exposed wafer is developed, parts other than residual photoresist, e.g., the exposed material surface, may be removed by etching. Finally, in step 1319, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, while the use of a force damper has been described as being used to dampen vibrations associated with a beam structure or a part of a motor, a force damper may be used to dampen vibrations in substantially any structure in which it is desirable for vibrational energy to be absorbed or dissipated. Such structures may include, but are not limited to, substantially any structure in which precision measurements or positioning may be affected by vibrations.

While the force applied by a clamping device or a force generator against dampers on substantially opposing sides of a structure such as a beam has been described as being approximately equal in magnitude, it should be appreciated that the magnitude of the forces may also be varied. In addition, the magnitudes of the forces actually applied to the structure may be varied, even if the magnitude of the forces applied by the force generator is substantially the same. For example, the dampers on which the forces are applied by the force generator may differ to effectively vary the magnitude of the forces applied against the structure. To vary the magnitude of the forces, the material from which the dampers are formed may vary, e.g., a “top” damper may be formed from one material while the “bottom” damper may be formed from a different material. The thickness, density, shape, width, length, and location of the dampers may also be varied to vary the forces on the structure.

Absorbers or energy dissipators have generally been described as being rubber pads. It should be understood, however, that generally any suitable material may be used as an absorber. Suitable materials include, but are not limited to, flexible, relatively elastic materials such as rubber, foam, and various polymers. In some embodiments, relatively inflexible or inelastic materials may also be used as absorbers.

Clamps such as C-clamps are effective for use to apply force to absorbers. As described above with respect to FIG. 6, force may be applied to absorbers by an approximation of a clamp that is formed from a threaded rod and bolts which apply forces to absorbers. In general, other mechanisms may be used to apply force to absorbers. Such mechanisms may include, for example, rubber bands which may be wound around the absorber and a structure which is subject to vibrations. When rubber bands are used to apply force, the rubber bands may be used without separate absorbers. That is, a rubber band may serve as both a source of force and an absorber without departing from the spirit or the scope of the present invention. Therefore, the present examples are to be considered as illustrative and not restrictive, and the invention is not to be limited to the details given herein, but may be modified within the scope of the appended claims.

What is claimed is:

1. A structure comprising:
a mass, the mass having at least a first surface and a second surface, the mass being arranged to transfer vibratory energy; and
a vibration damper, the vibration damper including a force adjuster, the vibration damper further including a first energy dissipator and a second energy dissipator, the vibration damper being positioned about the mass such that the first energy dissipator is in contact with the first surface of the mass and the second energy dissipator is in contact with the second surface of the mass, the first energy dissipator and the second energy dissipator being arranged to absorb the vibratory energy transferred by the mass, wherein the force adjuster is arranged to adjust force on the first energy dissipator and force on the second energy dissipator.

2. A structure according to claim 1 wherein the force adjuster is arranged to increase the force on the first energy dissipator and the force on the second energy dissipator, whereby increasing the force on the first energy dissipator and the force on the second energy dissipator increases an amount of vibratory energy absorbed by the first energy dissipator and the second energy dissipator.

3. A structure according to claim 1 wherein the force adjuster is arranged to adjust the force on the first energy dissipator and the force on the second energy dissipator substantially simultaneously.

4. A structure according to claim 3 wherein the force adjuster is a clamp.

5. A structure according to claim 3 wherein the vibration damper includes a spring, the spring being arranged to compress to adjust the force on the first energy dissipator and the force on the second energy dissipator, wherein the force adjuster is arranged to compress the spring, the spring further being arranged to decompress to adjust the force on the first energy dissipator and the force on the second energy dissipator, wherein the force adjuster is further arranged to decompress the spring.

6. A structure according to claim 1 wherein the mass is a beam.

7. A structure according to claim 1 wherein the mass is an I-core, the I-core being a part of an EI-core motor.

8. A structure according to claim 1 wherein the first surface of the mass is not in direct contact with the second surface of the mass.

9. A structure according to claim 1 wherein the force on the first energy dissipator substantially opposes the force on the second energy dissipator.

10. A structure according to claim 1 wherein the first energy dissipator and the second energy dissipator are formed from a rubber material.

11. A structure comprising:
a mass, the mass having at least a first surface and a second surface, the mass being arranged to transfer vibratory energy, the vibratory energy being arranged to cause the mass to vibrate; and
a force damper, the force damper including a first absorber and a second absorber, the force damper being positioned about the mass such that the first absorber is in contact with the first surface of the mass when the force damper applies a first force to the first surface of the mass and the second absorber is in contact with the second surface of the mass when the force damper applies a second force to the second surface of the mass, the first absorber and the second absorber being arranged to absorb the vibratory energy transferred by the mass when the force damper applies the first force and the second force, wherein the first force substantially opposes the second force.

12. A structure according to claim 11 wherein a magnitude of the first force is substantially equal to a magnitude of the second force.

13. A structure according to claim 11 wherein the first force is applied to the first surface of the mass through the first absorber, and the second force is applied to the second surface of the mass through the second absorber.

14. A structure according to claim 13 further including an adjuster that is arranged to be adjusted to vary at least one of the first force and the second force.

15. A structure according to claim 14 wherein an amount of the vibratory energy absorbed by the first absorber and the second absorber is varied when at least one of the first force and the second force are varied.

16. A structure according to claim 11 wherein the mass has a first mass and the adjuster has a second mass, the first mass being substantially larger than the second mass.

17. A structure according to claim 11 wherein the mass is a cantilevered beam;

18. A structure according to claim 18 wherein cantilevered beam is a moving cantilevered beam.

19. A structure according to claim 11 wherein the mass is a part of an EI-core motor.

20. A stage assembly suitable for use in wafer processing, comprising:
a base;
a stage;
a mount, the mount being coupled to the base, the mount being arranged to transfer vibratory energy, the mount having a first surface and a second surface;
a sensor, the sensor being coupled to the mount, the sensor being arranged to measure a position of the stage; and
a force damper, the force damper including a first absorber and a second absorber, the force damper being positioned about the mount such that the first absorber is in contact with the first surface of the mount when the force damper applies a first force to the first surface of the mount and the second absorber is in contact with the second surface of the mount when the force damper applies a second force to the second surface of the mount, the first absorber and the second absorber being arranged to absorb the vibratory energy transferred by the mount when the force damper applies the first force and the second force, wherein the first force substantially opposes the second force.

21. An exposure apparatus comprising the stage assembly of claim 20.

22. A device manufactured with the exposure apparatus of claim 21.

23. A wafer on which an image has been formed by the exposure apparatus of claim 21.

24. A stage assembly, comprising:
a stage, the stage being arranged to transfer vibratory energy, the stage having a first surface and a second surface; and
a force damper, the force damper including a first absorber and a second absorber, the force damper being positioned about the stage such that the first absorber is in contact with the first surface of the stage when the force damper applies a first force to the first surface of the stage and the second absorber is in contact with the second surface of the stage when the force damper applies a second force to the second surface of the stage, the first absorber and the second absorber being arranged to absorb the vibratory energy transferred by the stage when the force damper applies the first force and the second force, wherein the first force substantially opposes the second force.

25. An exposure apparatus comprising the stage assembly of claim 21.

26. A device manufactured with the exposure apparatus of claim 25.

27. A wafer on which an image has been formed by the exposure apparatus of claim 25.

28. A method for suppressing vibrations in a structure, the structure including a mass, the mass having a first surface and a second surface, the mass having vibratory energy, the method comprising:
providing a first absorber on the first surface;
providing a second absorber on the second surface;
applying a first force to the first absorber, the first force having a first magnitude, wherein the first absorber is arranged to absorb a first amount of the vibratory energy; and
applying a second force to the second absorber, the second force having a second magnitude, the second magnitude being approximately equal to the first magnitude, wherein the second absorber is arranged to absorb a second amount of the vibratory energy.

29. A method as recited in claim 28, wherein the first amount of the vibratory energy that is absorbed by the first absorber is dependent on at least physical properties of the first absorber and the first magnitude, and the second amount of the vibratory energy that is absorbed by the second absorber is dependent on at least physical properties of the second absorber and the second magnitude.

30. A method as recited in claim 28 wherein the first force and the second force are applied in substantially opposing directions along an axis of the device.

31. A method for positioning an object, the method comprising:
moving the object along a predetermined direction;
measuring a position of the object using a sensor connected to a sensor mount;
applying a first force to a first surface of the sensor mount, the first force having a first magnitude; and
applying a second force to a second surface of the sensor mount, the second force having a second magnitude that is substantially equal to the first magnitude.

32. A method for operating an exposure apparatus comprising the method for positioning an object of claim 31.

33. A method for making an object including at least a photolithography process, wherein the photolithography process utilizes the method of operating an exposure apparatus of claim 32.

34. A method for making a wafer utilizing the method of operating an exposure apparatus of claim 32.
